(19) United States
(12) Patent Application Publication
(10) Pub. No.: US 2010/0030866 A1
(43) Pub. Date: Feb. 4, 2010

(54) METHOD AND SYSTEM FOR REAL-TIME CLOUD COMPUTING

(75) Inventor: Harmeek Singh Bedi, Redwood City, CA (US)

Correspondence Address: PERKINS COIE LLP, P.O. BOX 1208, SEATTLE, WA, 98111-1208, US

(73) Assignee: Ameya Computing, Inc., Redwood City, CA (US)

(21) Appl. No.: 12/508,216

(22) Filed: Jul. 23, 2009

Related U.S. Application Data
(60) Provisional application No. 61/135,847, filed on Jul. 23, 2008.

(51) Int. Cl. G06F 15/167

(52) U.S. Cl. 709/212

(57) ABSTRACT

A system for providing real-time cloud computing. The system includes a plurality of computing nodes, each node including a CPU, a memory, and a hard disk. The system includes a central intelligence manager for real-time assigning of tasks to the plurality of computing nodes. The central intelligence manager is configured to provide CPU scaling in parallel. The central intelligence manager is configured to provide a concurrent index. The central intelligence manager is configured to provide a multi-level cache. The central intelligence manager is configured to provide direct disk reads to the hard disks. The central intelligence manager is configured to utilize UDP for peer-to-peer communication between the computing nodes.

### CROSS REFERENCE TO RELATED APPLICATIONS

This application claims priority to provisional application Ser. No. 61/135,847 entitled “REAL-TIME CLOUD COMPUTER”, filed Jul. 23, 2008, and which is incorporated herein by reference.

### BACKGROUND

Current Internet applications face significant challenges:

There can be millions of users, including hundreds of thousands using the application concurrently.

The applications can be data intensive.

The applications can require real-time processing.

Therefore, applications are data intensive and have high concurrency requirements.

Current technologies fall short and fail to meet these needs:

There is no standard solution available to provide such applications.

Previous attempts to address these problems include: Database+Open Source Caching (Squid/Memcache), SAN+Open Source Caching (Squid/Memcache), Hybrid−Database for Metadata, SAN for Data

Unfortunately, all of the above involve inefficient utilization of computing resources. Therefore, there is a need for an improved method and system for providing real-time cloud computing.

### BRIEF DESCRIPTION OF DRAWINGS

The features and objects of the present disclosure will become more apparent with reference to the following description taken in conjunction with the accompanying drawings wherein like reference numerals denote like elements and in which:

FIG. 1 illustrates an example system utilizing a central intelligence manager.

FIG. 2 illustrates an example computing node in communication with a central intelligence manager.

### DETAILED DESCRIPTION

In one embodiment, a computing system is optimized for maximum resource utilization. This includes optimizing CPU, network bandwidth, and memory utilization.

In one embodiment, the computing system provides the following features:
Clustered N-Tier Cache
Built-in Parallelism
Designed for Massive Concurrency
Runs on Commodity Hardware+Linux
Designed for guaranteed Quality of Service

Optimizing CPU, Network and Memory

The problem can be described as:
1000s of cheap computers (nodes), each with inexpensive CPU, Memory and Hard disk
Millions of users—some requesting CPU heavy tasks, some network heavy and some memory or disk heavy, some all three
Internet response time
Data Intensive applications

An analogy can be described as:
Millions of customers who want to process letters
People are organized in teams. Each team has 3 people—1 person types, 1 person staples and one person puts the letter in an envelope
Some customers only want letters to be typed, some want only stapling and some want putting in envelopes, some all three
Customers have to be served within a timeframe

The problem can be described as:
To utilize resources fully we need a system that knows how much each node is loaded in terms of CPU, memory and bandwidth
Quick way to identify the nature of request and quick routing. We maintain a “Master Information Repository”

An analogy can be described as:
To utilize resources fully, the office manager needs to know who is doing what in real-time
Customer requests need to be channeled to the most under utilized resources quickly—if not they will start piling up. We appoint a “Central Intelligence Manager”

CPU Scaling

An analogy can be:
What if a customer arrives and asks for a letter to be delivered in ⅕th the usual time? A single typist cannot meet this request.

An analogy Solution can be:
“Central Intelligence Manager” breaks the number of pages into 5 bunches and assigns it to 5 different typists

A real problem can be:
Real-Time network intrusion analysis requires analyzing packets at network speed (1 Gbps). No CPU can process at this speed hence the packets need to be divided amongst multiple CPUs.
When streaming Video-on-demand, certain content like Advertisement must be delivered

A real solution can be:
Pipeline Parallelism
Independent Parallelism
Ability to distribute computational tasks and data
Can take an existing application—like a JAVA internet application and parallelize it to get significantly better performance

Highly Concurrent Index

An analogy can be:
Given that 1000s of resources are finishing tasks rapidly, the “Central Intelligence Manager” file needs to be kept up to date quickly. However, resources should not get bottlenecked waiting to give status to this central manager

An analogy solution can be:
“Central Intelligence Manager” manages information that is organized into files—For example Typists 1-100, Typists 101-200, Stapler 1-50, Stapler 51-100 etc. So if Typist 10 needs to update his status, only one file called Typist 1-100 is locked for updating instead of having to interact with the office manager.

A real problem can be:
Master information stored and organized similar to B-Tree indexes for quick storage and retrieval
However, B-Tree locks are not concurrent

A real solution can be:
Writers do not block readers
Only one side of the tree is updated, so the other side of the tree is considered to have reliable information

Memory Scaling—Multi-Level Cache

An analogy can be:
How to get the most out of the typists?
Challenge: How do you keep real-time and reliable information?

An analogy solution can be:
Frequency count of words and phrases is maintained.
Most commonly requested, least requested, end user tagged. Certain words such as ‘and’, ‘the’, ‘of’ etc. are always cached
If a page or paragraph was typed by another typist and is available in his computer program, it is cut-pasted from there.
“Central Intelligence Manager” cannot take a break

A real problem can be:
100K feature length movies cannot be stored in a memory simultaneously

A real solution can be:
If a block of movie was delivered by a node it is cached.
Depending on the frequency of use the cache is stored in multiple levels
Any node might get a user that requests the movie but the request may be served by another node
Real-time and reliable information on which node has cached what is stored in permanent cache—even OS cannot swap it out.

Disk and Network Scaling—Zero Copy

An analogy can be:
A typist reads the hand written letters and types them in the computer program before sending to print. This is slow.

An analogy solution can be:
To speed the operation, we have given the typists some scanners to read the characters from the pages.
We have also figured out a way to send the scanned information directly to print streams thereby bypassing the needs to type the letters in a computer program

A real problem can be:
Disk I/O is a slow because data is read from disk controller to kernel buffers and then to user buffers.
Over the network the data is copied across the TCP/IP stack layers from one layer to other

A real solution can be:
Our system reads directly from Disk into session buffers
We also transfer data directly from user buffer to network
Our system delivers packets from Network TCP to IP stack, Kernel buffer to device driver buffer and uses UDP.

Network Scaling

An analogy can be:
Letters are put in envelopes and the final person to do this waits for the customer to deliver the letter. This ends up under utilizing this person's time

An analogy solution can be:
Instead of waiting for the customer, the person who puts the letter in the envelope, marks the envelope for the customer, ties a string around the envelope and sends it down the chute. This person then goes on to serving other customer requests but checks from time to time if the customer picked up the letter.

A real problem can be:
TCP/IP is reliable but inefficient protocol as compared to UDP

A real solution can be:
We use UDP for all peer-peer node communication.
The system has TCP like reliability built on top of UDP

HA Clustering

An analogy can be:
The “Central Intelligence Manager” may fall sick

An analogy solution can be:
The organization Maintains multiple “Central Intelligence Managers” each with same information

A real problem can be:
How to ensure high availability if the master node goes down?

A real solution can be:
The system has a way to figuring out the next best master node and that node is assigned to become master node.

The disclosed methods and systems can be used for a variety of different platforms and applications. For example, one application is video on demand, including feature length and TV quality videos. For example, another application is Clickstream, providing real-time log file data analysis. For example, another application is on-demand cloud computing providing social network, photo sharing, or video sharing application. For example, another application is a cloud computer, commodity hardware, and real-time processing. For example, another application is storage as a service. For example, another application is real-time network intrusion detection.

The disclosed methods and systems can be monetized in a variety of ways. For example, one could build an application. Potential customers would be application specific. For example: video on-demand customers could be consumers as well as business like Media Industry and other content owners

In another example, one could build a platform. Potential customers would be financial services, media, social networking, and government.

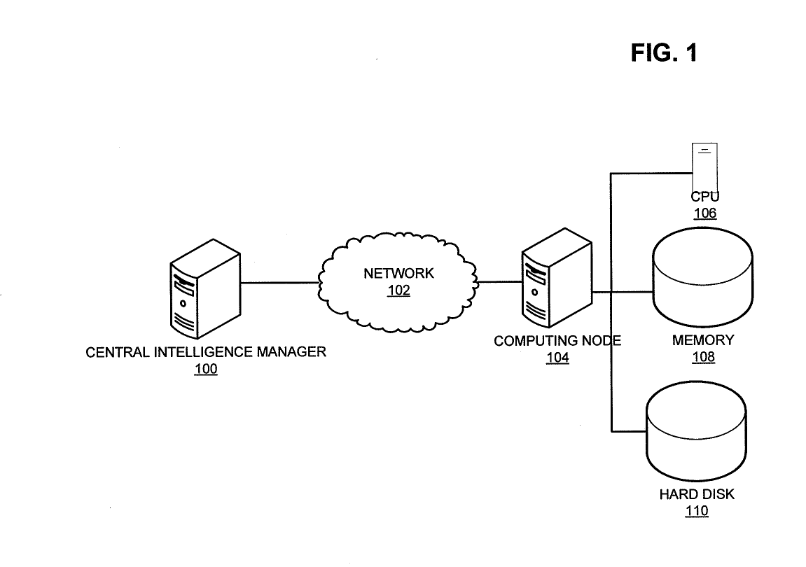

FIG. 1 illustrates an example system utilizing a central intelligence manager. A central intelligence manager 100 can be configured to perform the functionality discussed above. The central intelligence manager 100 can communicate over a network 102 with a computing node 104.

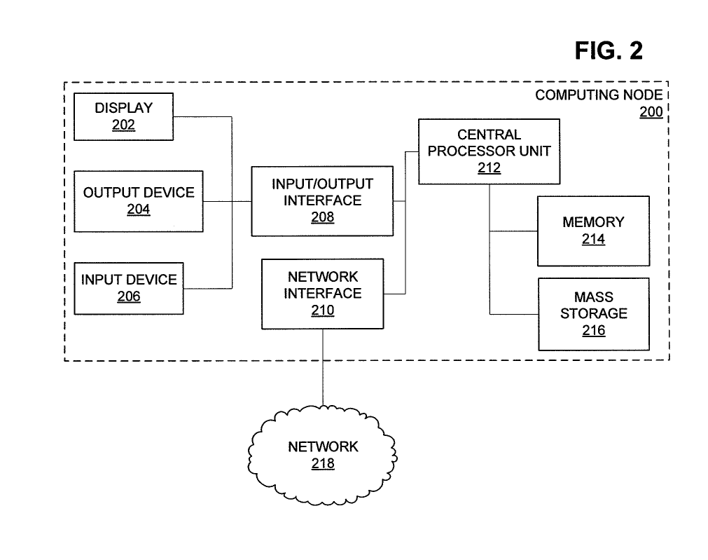

The computing node 104 can include or access a CPU 106, a memory 108, and a hard disk 110. The computing node 104 can be as illustrated in FIG. 2.

It will be appreciated that while only one computing node 104 is illustrated, any number of computing nodes can exist in the system. In one embodiment, a plurality of computing nodes are controlled by the central intelligence manager 100.

FIG. 2 illustrates an example computing node in communication with a central intelligence manager. A computing node 200 is configured to communicate with central intelligence manager, as illustrated in the system of FIG. 1.

The computing node 200 includes a display 202. The display 202 can be equipment that displays viewable images, graphics, and text generated by the computing node 200 to a server administrator. For example, the display 202 can be a cathode ray tube or a flat panel display such as a TFT LCD. The display 202 includes a display surface, circuitry to generate a viewable picture from electronic signals sent by the computing node 200, and an enclosure or case. The display 202 can interface with an input/output interface 208, which converts data from a central processor unit 212 to a format compatible with the display 202.

The computing node 200 includes one or more output devices 204. The output device 204 can be any hardware used to communicate outputs to the administrator. For example, the output device 204 can be audio speakers and printers or other devices for providing output.

The computing node 200 includes one or more input devices 206. The input device 206 can be any hardware used to receive inputs from the administrator. The input device 206 can include keyboards, mouse pointer devices, microphones, scanners, video and digital cameras, etc.

The computing node 200 includes an input/output interface 208. The input/output interface 208 can include logic and physical ports used to connect and control peripheral devices, such as output devices 204 and input devices 206. For example, the input/output interface 208 can allow input and output devices 204 and 206 to communicate with the computing node 200.

The computing node 200 includes a network interface 210. The network interface 210 includes logic and physical ports used to connect to one or more networks. For example, the network interface 210 can accept a physical network connection and interface between the network and the workstation by translating communications between the two. Example networks can include Ethernet, the Internet, or other physical network infrastructure. Alternatively, the network interface 210 can be configured to interface with wireless network. Alternatively, the computing node 200 can include multiple network interfaces for interfacing with multiple networks.

As depicted, the network interface 210 communicates over a network 218. Alternatively, the network interface 210 can communicate over a wired network. It will be appreciated that the computing node 200 can communicate over any combination of wired, wireless, or other networks.

The computing node 200 includes a central processing unit (CPU) 212. The CPU 212 can be an integrated circuit configured for mass-production and suited for a variety of computing applications. The CPU 212 can sit on a motherboard within the computing node 200 and control other workstation components. The CPU 212 can communicate with the other workstation components via a bus, a physical interchange, or other communication channel.

The computing node 200 includes memory 214. The memory 214 can include volatile and non-volatile memory accessible to the CPU 212. The memory can be random access and provide fast access for graphics-related or other calculations. In an alternative embodiment, the CPU 212 can include on-board cache memory for faster performance.

The computing node 200 includes mass storage 216. The mass storage 216 can be volatile or non-volatile storage configured to store large amounts of data. The mass storage 216 can be accessible to the CPU 212 via a bus, a physical interchange, or other communication channel. For example, the mass storage 216 can be a hard drive, a RAID array, flash memory, CD-ROMs, DVDs, HD-DVD or Blu-Ray mediums.

The computing node 200 communicates with a network 218 via the network interface 210. The network 218 can be as discussed above in FIG. 2. The computing node 200 can communicate with a mobile device over the network 218.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A system for providing real-time cloud computing, comprising:
a plurality of computing nodes, each node including a CPU, a memory, and a hard disk; and
a central intelligence manager for real-time assigning of tasks to the plurality of computing nodes, the central intelligence manager further configured to,
provide CPU scaling in parallel,
provide a concurrent index,
provide a multi-level cache,
provide direct disk reads to the hard disks, and
utilize UDP for peer-to-peer communication between the computing nodes.
